(19) United States
(12) Patent Application Publication
(10) Pub. No.: US 2018/0202270 A1
(43) Pub. Date: Jul. 19, 2018

(54) JET PUMP MANUFACTURED USING ADDITIVE AND SUBTRACTIVE MACHINING TECHNIQUES

(71) Applicant: SOURCE ROCK ENERGY PARTNERS INC., Calgary (CA)

(72) Inventors: Kellly Falk, Calgary (CA); Brandon Yorgason, Rockyford (CA)

(21) Appl. No.: 15/744,209

(22) PCT Filed: Jul. 13, 2016
(86) PCT No.: PCT/CA2016/050827

§ 371 Date: Jan. 12, 2018

Related U.S. Application Data
(60) Provisional application No. 62/191,875, filed on Jul. 13, 2015.

(51) Int. Cl. E21B 43/12; B23K 26/34; B23K 26/354; B23C 3/16; F04F 5/10; F04F 5/46; B33Y 80/00; B33Y 70/00; B28B 1/00

(52) U.S. Cl. CPC E21B 43/124; B23K 26/34; B23K 26/354; B23C 3/16; B33Y 10/00; F04F 5/464; B33Y 80/00; B33Y 70/00; B28B 1/001; F04F 5/10

(57) ABSTRACT

A jet pump is manufactured using additive and subtractive techniques. A tubular body and a diffuser formed therein form a monolithic structure. The tapered diffuser is continuously curved from a throat end to a discharge end. A cross-sectional area at the discharge end is optimized without compromising a cross-sectional area of a production conduit defined in an annular space between the body and the diffuser. The body can be shaped to include radially extending localized or circumferential protrusions to maximize fluid conduits within the pump. A one-way valve is formed within the production conduit using the additive and subtractive techniques and is integrated in the monolithic structure.

### CROSS-REFERENCE TO RELATED APPLICATIONS

This application claims the benefit of claims the benefit of U.S. provisional application 62/191,875, filed Jul. 13, 2015, the entirety of which is incorporated herein by reference.

### FIELD

Embodiments disclosed herein relate to jet pumps and, more particularly, to jet pumps manufactured with integrated components to provide improved pumping performance and pump life.

### BACKGROUND

Jet pumps are well known for use in a variety of environments, including, but not limited to, wellbore applications for pumping production fluids, typically at least water and hydrocarbons. A conventional jet pump typically comprises a venturi through which a power fluid, such as water, is injected from surface for causing a pressure drop at the venturi creating suction. The suction induces produced fluids to be drawn into an intake passage in the pump for delivery to a throat which is fluidly connected to the venturi. The produced fluids mix with the power fluid therein forming a flow of return fluid to a diffuser which increases in diameter toward the discharge end thereof for increasing the pressure of the return fluid. The return fluid is then discharged from the diffuser to an annulus, such as between the pump and the wellbore, the increased pressure causing the return fluid to rise therein to surface. Generally an injection flow of the power fluid and a return flow of mixed power fluid and production fluids are facilitated by two discrete flow paths within the wellbore, one for the injection flow to the pump and the other for the return flow from the pump.

A conventional jet pump is typically manufactured from a variety of machined or welded components which are threaded or otherwise connected together to create the different flow conduits within the pump. The process of creating the flow conduits requires complex manufacturing steps. Thereafter, the conduits may be coated with other materials to improve the surface characteristics, such as to harden the surface to resist erosion by abrasive fluids flowing therethrough. The use of hardened materials for wear resistance is contrary to more malleable materials need for structure and assembly.

As a result of the conventional manufacturing processes used, such as casting, forming, welding and milling, the internal geometries of the pump, particularly the diffuser and the intake flow area, may be limited. Alternatively, if conventional manufacturing methods were possible to produce parts to form a component having a non-conventional geometry, the cost would increase significantly. Generally despite having a unique geometry, parts formed using conventional methods still require welding or other form of mechanical assembly to form the various interconnected flow passages.

One such exemplary jet pump is taught in Applicant's co-pending published US application 2013/0084194, which is incorporated herein by reference in its entirety. As one of skill in the art will appreciate, the cost and complexity of manufacture of such a pump is significant as a result of the number of components which must be joined at connections, either by welding or threading together or otherwise, therein. Further, structural or pressure integrity and material properties may be compromised at each connection. Further still, the connections may present areas which are more readily compromised by erosion. As will be appreciated, the cost of pulling a pump from the wellbore to service or replace worn components of the pump, or the pump itself, adds significantly to the cost of a downhole operation.

With respect to pumping, the efficiency of such a pump may be affected by the use of conventional elbows which provide a relatively restricted cross-sectional area at the discharge of the diffuser, thereby limiting the pressure to which the exiting fluid can be raised in the diffuser. The angle at which the return fluids exit the elbow-like discharge end of the diffuser to the annulus, is conventionally about 30 degrees. The transition from the axial flow of fluid through the diffuser to radial flow through the elbow-like discharge renders the diffuser prone to erosion. The diffuser is typically coated with tungsten carbide after the components are manufactured, adding additional steps and cost to the manufacturing process. Efficiency of pumping is also affected by surface finish within the flow conduits and components. Where conventional machining may adversely affect the surface finish, other processes may be required to restore or enhance the surface finish to ensure efficient pumping.

Conventional diffusers typically have a cylindrical outer diameter and a tapered inner diameter. The inner diameter tapers outwardly from an upstream end connected to the throat to the downstream discharge end. Manufacture of the inner diameter taper expansion from the narrower throat end to wider discharge end is difficult using conventional manufacturing techniques. Therefore, a length of the taper expansion interval is typically limited by manufacturing capabilities.

Further, if the cylindrical diffuser is lengthened in an effort to create a wider discharge for increasing the cross-sectional area thereat, the cylindrical outer diameter of the diffuser necessarily becomes larger and encroaches on the internal diameter of the pump, reducing the cross-sectional area available for the intake passage. Pumping efficiency is then compromised.

There is interest in the industry for jet pumps which overcome problems related to conventional pump manufacture, which are more efficient and which are of lower cost.

### SUMMARY

Embodiments of a jet pump are manufactured using additive and subtractive machining techniques suitable for use with metal which permit new arrangements heretofore unavailable to pump designers. As a result, the present embodiments demonstrate simplification of design, a reduction in components and connections and the ability to optimize flow conduits and pump performance.

The additive and subtractive manufacturing techniques are used to form a monolithic structure having a diffuser and production fluid conduit defined therein. The diffuser is shaped and configured to optimize a cross-sectional area of a discharge end without impinging on the production fluid conduit thus optimizing pump performance. Further, in embodiments, a one-way valve in the production fluid conduit is also formed as part of the monolithic structure, eliminating the need to separately manufacture and assemble the one-way valve into the pump.

Materials for manufacture can be modified, such as by using metal composites, which comprise two or more materials in varying ratios throughout the 3-D printed components to meet design specifications. Thus, conventional coating of the inner surface of parts, such as the throat and the diffuser, using abrasive resistant materials can generally be eliminated and costs further reduced. Further, materials that cannot typically be used during conventional manufacturing processes, but which can be 3-D printed can be used.

In a broad aspect, a jet pump, having a venturi for delivering a power fluid to a throat located downhole thereof and a plurality of ports formed therebetween for inducing production fluid into the throat, comprises a tubular body having an uphole end for connection to a tubing string and a downhole intake end for receiving production fluid from the formation and a diffuser located in the body, extending generally axially therein from the throat and continuously curving therealong to a discharge end in the body, the diffuser forming an annular space between the diffuser and the body, the annular space acting as a production conduit in fluid communication with the intake end for delivering the production fluid to the plurality of ports. The tubular body and diffuser are additively and subtractively formed as a monolithic structure.

When the jet pump is deployed in a wellbore and forms an annulus therebetween, a cross-sectional area at the discharge end of the diffuser is about a cross-sectional area of the annulus.

The jet pump further comprises a one-way valve formed in the production conduit adjacent the intake end of the body for allowing production fluid into the production conduit, the one-way valve being formed integral with the monolithic structure.

In another broad aspect, a method of manufacturing a jet pump, having a venturi for delivering a power fluid to a throat located downhole thereof and a plurality of ports formed therebetween for inducing production fluid into the throat comprises forming a tubular body having an uphole end for connection to a tubing string and a downhole intake end for receiving production fluid from the formation. A diffuser is formed within the tubular body extending generally axially therein, forming an annular space between the diffuser and the body, the annular space acting as a production conduit in fluid communication with the intake end. The diffuser is continuously curved therealong from the throat to a discharge end in the body and tapering from narrow at the throat to wider at the discharge end for optimizing a cross-sectional area of the discharge end. The body and the diffuser are additively and subtractively formed as a monolithic structure.

### BRIEF DESCRIPTION OF THE DRAWINGS

FIG. 1 is a cross-sectional view of a prior art jet pump, manufactured using conventional methodologies and having multiple components conventionally connected for forming the pump;

FIG. 2A is a cross-sectional view of a jet pump according to an embodiment taught herein and manufactured using additive and subtractive machining and having a minimum of components therein;

FIG. 2B is a plan view of a one-way valve in a production fluid conduit in the jet pump of FIG. 2A;

FIG. 2C is a cross-sectional view according to FIG. 2A, along lines A-A;

FIG. 3A is a cross-sectional view of a jet pump according to another embodiment taught herein and manufactured using additive and subtractive machining;

FIG. 3B is a partial cross-sectional view of the jet pump of FIG. 3A, illustrating increased cross-sectional area of the discharge end of the diffuser in contrast to the discharge end of the diffuser in the prior art pump of FIG. 1; and

FIG. 4 is a cross-sectional view according to FIG. 3A, along lines B-B.

### DETAILED DESCRIPTION

### Prior Art

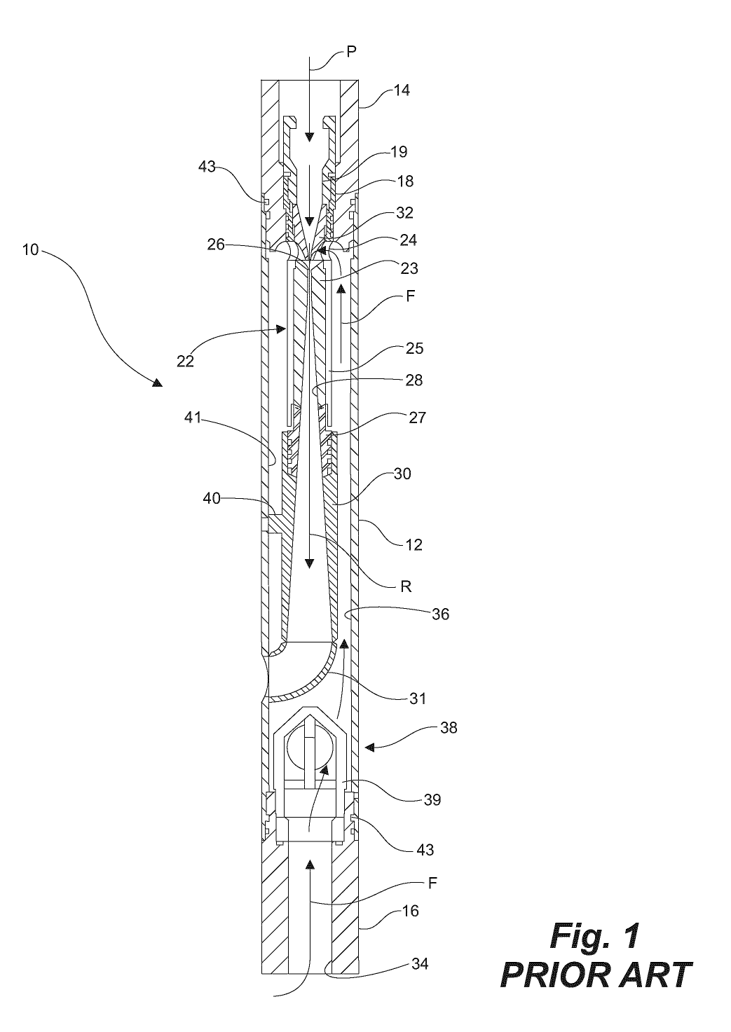

Having reference to FIG. 1, the jet pump 10 taught in Applicant's co-pending published US 2013/0084194 includes a jet pump body 12 having an uphole end 14 and a downhole end 16. The uphole end 14 of the jet pump body 12 is fluidly connected to a tubing string for deploying the pump 10 into a wellbore and for providing a power fluid P to the jet pump 10 as described below. The jet pump body 12 further comprises a carrier seat 18 formed therein adjacent the uphole end 14 and in fluid communication with a power fluid conduit 20, fluidly connecting between the tubing string, the carrier seat 18 and to a throat 22 supported below the carrier seat 18. A plurality of ports 24 are formed between the carrier seat 18 and the throat 22. The throat 22 has a narrow inlet 26 adjacent the plurality of ports 24 and a widened outlet 28 which is fluidly connected to a discharge conduit or diffuser 30 having a diffuser elbow 31 fluidly connecting between the diffuser 30 and an annulus A_{A}, such as between the pump 10 and the wellbore W. A venturi 32 is releasably supported within the carrier seat 18, forming a gap between the carrier seat 18 and the throat 22 at the ports 24.

A production fluid intake 34, proximate the downhole end 16, receives production fluid F entering the wellbore through perforations therein and directs the production fluid F to an axially extending production conduit 36 within the pump body 12. The production conduit 36 is fluidly connected between the intake 34 and the ports 24 between the carrier seat 18 and the throat 22. A one-way valve, typically a standing valve 38 comprising a valve cage 39 and a ball 44, is positioned in the production conduit 36 adjacent the intake 34 for permitting production fluid F to enter the production conduit 36 and blocking flow therefrom to below the one-way valve 38.

In operation, power fluid P flows from the tubing string into the venturi 32 via the power fluid conduit 20. The power fluid P flows past the ports 24 and the gap formed between the carrier seat 18 and the throat 22, creating a lower pressure thereat. The lower pressure condition forms a suction at the ports 24 which induces production fluid F to flow into the intake 34, through the one-way valve 38, the production conduit 36 and the ports 24 into the throat 22. The production fluid F combines with the power fluid P in the throat 22, which acts as a mixing tube to form a return fluid R. As the return fluid R reaches the wider end of the throat 22 and the diffuser 30 and diffuser elbow 31, the increased cross-sectional area therein, relative to the venturi 32 and the narrow inlet 26 of the throat 22, acts to increase the pressure, providing impetus for lifting the return fluid R to surface in the annulus A_{A}.

As one of skill will appreciate having reference to FIG. 1, attempts to increase the cross-sectional area of the discharge end of the diffuser 30 by lengthening the cylindrical diffuser 30 or increasing cross-sectional area of the elbow 31 would necessarily result in an increase in the diameter of the diffuser. As a result the diffuser 30 and elbow 31 further encroach into the production conduit 36 affecting pump efficiency.

The jet pump 10 may be fit with a data tool for providing at least temperature and pressure data in real-time or in a memory mode, as described in US 2013/0084194.

Further, as described in US 2013/0084194, the venturi 32 and the throat 22 are removeably supported in a carrier 19 which is seated within the carrier seat 18. The carrier 19 can be removed from the seat 18 by reversing a flow of power fluid P in the pump 10 for lifting the carrier 19 to surface and can be inserted into the carrier seat 18 by pumping the carrier 19 down the tubing string into the seat using power fluid P. In this way the venturi 32 and throat 22 can be replaced if worn, or if required to change the size thereof without having to pull the pump 10 from the wellbore.

As is clear from FIG. 1, the prior art pump body 12 comprises a plurality of components which are threaded or welded together to form the body 12, the conduits 20, 30, 31, 36 and the one-way valve 38 therein. The diffuser elbow 31 is welded to the end of the diffuser 30 and is generally circular in cross-section and has a cross-sectional area substantially the same as that of a distal end of the diffuser 30. Further, the throat 22 comprises two separate pieces, an abrasion resistant inner portion 23 and an outer, stainless steel carrier assembly 25 which are supported within the body 12 using a downhole nut 27. An alignment pin 40 is used to properly align the diffuser 30 within a tubular bore 41 of the body 12 during assembly of the various components. Seals 43 are also required at each of the threaded connections to prevent leaks thereat.

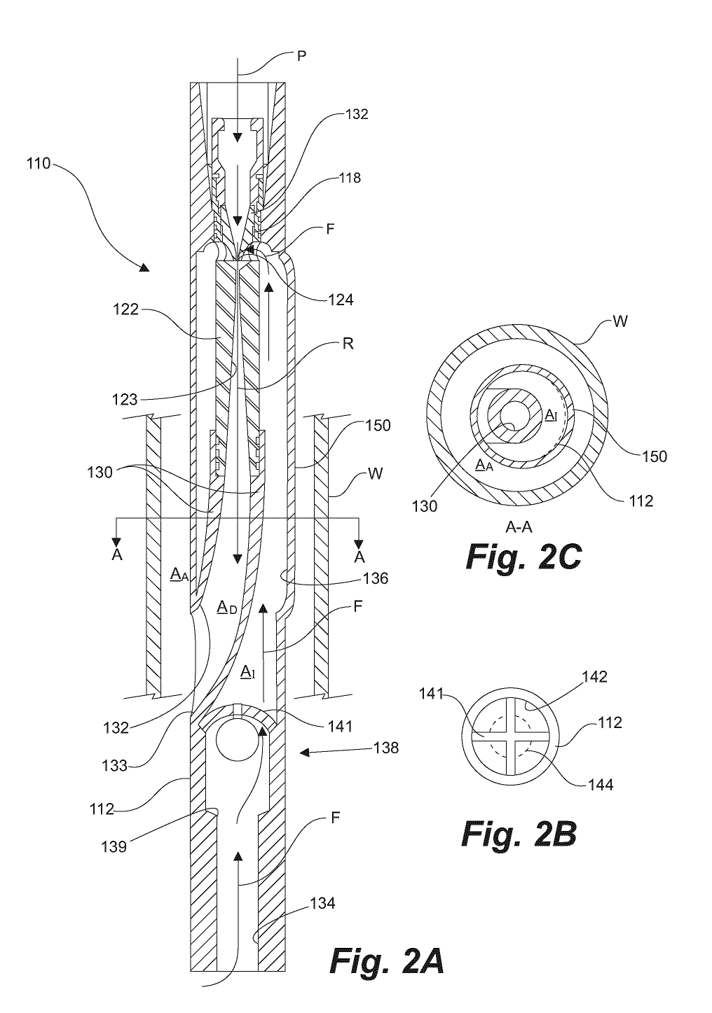

With reference to FIGS. 2A-4, in embodiments taught herein, jet pumps are manufactured using additive and subtractive machining techniques which permit new arrangements heretofore unavailable to pump designers. As a result the present embodiments demonstrate simplification of design, a reduction in components and the ability to optimize flow conduits and pump performance. The components can be designed to have flow passages which are not possible or are difficult and costly to produce using conventional manufacturing techniques. An improved pump results and costs are reduced as a result.

Further still, using such techniques, materials for manufacture can be modified, such as by using metal composites, which comprise two or more materials in varying ratios throughout the 3-D printed components to meet design specifications. For example, the metal composites include, but are not limited to, INCONEL®, an austenite nickel-chromium-based alloy and tungsten carbide and mixtures thereof.

Also, materials that are not typically considered for use with conventional manufacturing processes can be used in embodiments taught herein provided the materials are 3-D printable. Examples of such materials include, but are not limited to, diamond and STELLITE®.

Having reference to FIG. 2A, in an embodiment of a jet pump 110 taught herein, at least a body 112 of the pump 110 is a 3-D printed monolithic structure which defines the various flow conduits therein for function of the jet pump 110. While all of the components of the pump 110 can be integrated within the 3-D printed monolithic structure, in embodiments, a throat 122, carrier seat 118 and venturi 132 are separately manufactured and installed within the pump body 112 to allow removal and replacement for optimizing pump performance. The throat 122, carrier seat 118 and venturi 132 are releasably installed in and removed from the body 112, as desired, without having to pull the pump 110, as taught in US 2013/0084194.

As shown in FIG. 2A, and in contrast to FIG. 1, embodiments of the pump 110 eliminate a majority of threaded or welded connections and seals, eliminate the need for an alignment pin for assembly, eliminate the abrupt elbow at the discharge end of the diffuser, and eliminate a non-integrated one-way valve.

The body 112 is formed using an additive manufacturing technique which utilizes data from a CAD design to control laying down layers of a metal which are melted or sintered or otherwise fused together for forming the desired 3-D shape and configuration. Typically, a metal powder is applied in layers to the growing structure and a laser is used to melt or sinter the powder to further grow the structure. Suitable additive manufacturing techniques, generally 3-D metal printing techniques include, but are not limited to, one or more of direct metal laser melting (DMLM), direct metal laser sintering (DMLS), other any other 3-D printing technique suitable for use with metals.

Subtractive techniques, such as 5-axis milling, can be used in conjunction with the additive technique to further shape and configure areas of the body 112, as required to alter size and shape to optimize pump performance. One exemplary apparatus that can be used for forming the pump body is the LASERTEC 65 3D available from DMG MORI Europe AG (www.dmgmori.com) combines additive manufacturing using laser deposition welding with a powder nozzle with 5-axis milling, the additive and subtractive processes controlled by a hybrid CAD/CAM module.

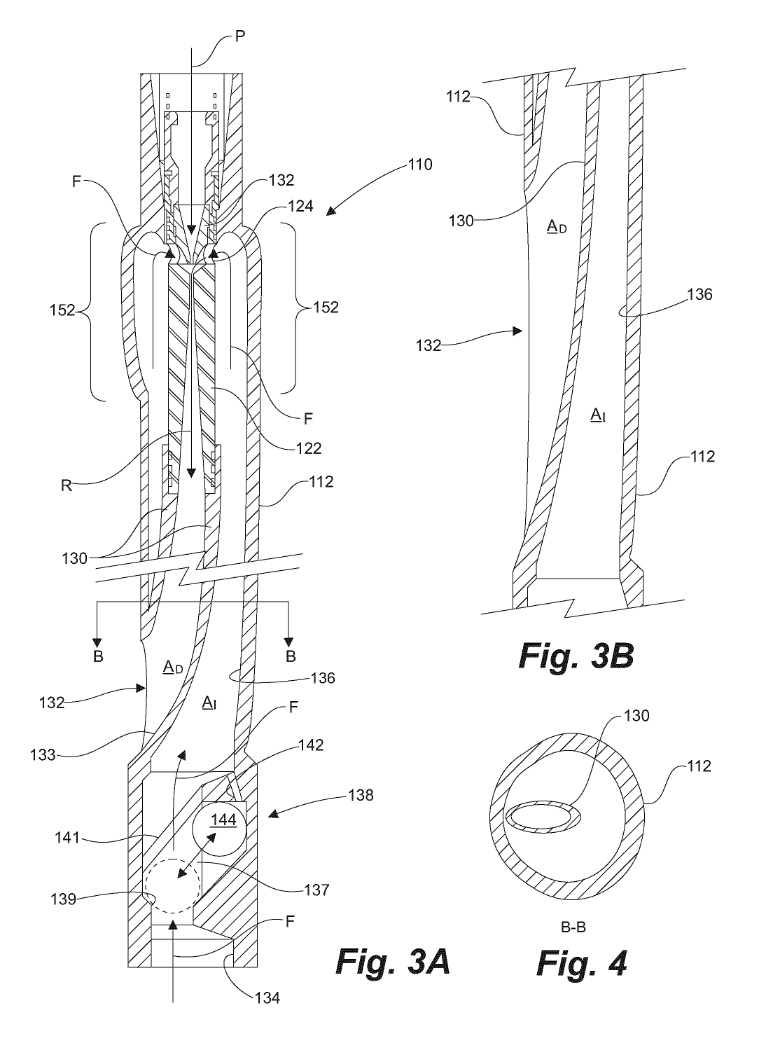

Having continued reference to FIGS. 2A, 2C and to FIGS. 3A, 3B and 4, unlike the prior art pump 10 of FIG. 1, a discharge conduit or diffuser 130 is formed within the monolithic body 112 and extends generally axially therein. The diffuser 30 is shaped and curved from the throat 122, to a discharge end 132 in the body 112 for fluidly connecting to an annulus A_{A} formed between the pump 110 and the wellbore W when deployed therein. The discharge end 132 has a cross-sectional area A_{D} that approaches the cross-sectional area of the annulus A_{A} to which the return fluid R is discharged. The ability to lengthen and shape the diffuser 130 as a unitary conduit having a continuous curve therealong to the optimized cross-sectional area A_{D} at the discharge end 132 eliminates the need for the conventional and abrupt diffuser elbow 31 (FIG. 1). The optimized cross-sectional area A_{D} optimizes the pressure to which the return fluid R can be raised at the discharge end 132 within a pump 110 having a body 112 of comparable diameter to that of the prior art pump 10.

As shown in FIG. 4, the cross-section of the diffuser 130 need not be circular. An elongate, ovoid diffuser 130 aids in increasing the cross-sectional area without substantially changing the diameter of the pump body 112 when compared to the prior art pump 10 of FIG. 1. In an embodiment, a major axis of the ovoid diffuser 130 is directed radially toward the discharge end 132.

An inner surface 133 of the diffuser 130 can be additively manufactured to have a metal composition at the inner surface 133 that is more resistant to erosion than a remainder of the diffuser 130 or of the body 112. Variable composition metal powders can be used, such as varying ratios of INCONEL® and tungsten carbide, at specific locations in the body 112 to provide different properties. In this case, an increase in the amount of tungsten carbide in the diffuser's inner surface 133 would enable greater resistance to erosion. Thus, the prior art step of coating the inner surface 133 of the diffuser 130 after manufacture can be eliminated.

Further, as a result of the ability to alter the composition of the metal powder used in the additive manufacturing techniques, the throat 122 is 3-D printed as a unitary tubular member. The unitary throat 122 eliminates the need for a separate support assembly. The entirety of the throat 122 or at least an inner surface 123 thereof, is manufactured as described above for the diffuser 130 to provide greater resistance to erosion. Thus, the prior art support assembly and the need to coat the inner surface of the throat are eliminated.

As shown in FIGS. 2A, 2B, 3A, 3B and 4, an annular space A_{I} between the diffuser 130 and the body 112 forms a production fluid conduit 136 integrally with the monolithic structure. The annular space A_{I} is non-uniform along its length. A one-way valve 138 is also integrally manufactured with the monolithic structure and in the production conduit 136. The one-way valve 138 is located adjacent an intake end 134 of the production fluid conduit 136 and is also additively and subtractively manufactured unitary with the monolithic body 112. A valve chamber 137 is shaped having a restricted inlet end 139 adjacent the pump's intake end 134 and a flow cage or cap 141 spaced thereabove having ports 142 formed therein to retain a ball 144 therein yet permit the flow of production fluid F therethrough. The ball 144 is freely moveable within the valve chamber 137. The one-way valve 138 acts in the same manner as the prior art one-way valve 38 described above. The ball 144 is additively and subtractively manufactured within the valve chamber 137, eliminating a conventional manufacture which must permit inserting the ball 144 therein. The ball 144 can be manufactured of the same or different material as the body 112. Further, the ball 144 can be manufactured to be hollow or otherwise. Thus, the prior art valve cage 39 and threaded connections between tubular sections of the body 12 which permit insertion of the one-way valve 38 into the production fluid conduit 36 are eliminated. Further, seals 43 are no longer needed as connections are eliminated.

To improve pump efficiency, the body 112 of the pump 110 can be configured to be other than circular and/or to have a variable geometry along a length of the body 112 to optimize a volume of fluids handled by the production fluid conduit 136 and the diffuser 130.

As shown in FIGS. 2A and 4, in an embodiment, a diameter of the production fluid conduit 136 is increased by providing a localized radially extending bulge or protrusion 150 along the pump body 112 defining the production fluid conduit 136.

Having reference to FIG. 3A, a radially extending, circumferential enlargement 152 can now be formed in the body 112 adjacent the plurality of ports 124 that fluidly connect the production fluid conduit 136 with the venturi 132 and the throat 122. The circumferential enlargement 152 increases the diameter of the production fluid conduit 136 thereat, which acts as a chamber to aid in directing the flow of production fluid F. The production fluid F flows from the production fluid conduit 136 into the ports 124 to mix and flow with the power fluid P, flowing in the opposite direction through the venturi 132.

The embodiments in which an exclusive property or privilege is claimed are defined as follows:

1. A jet pump, having a venturi for delivering a power fluid to a throat located downhole thereof and a plurality of ports formed therebetween for inducing production fluid into the throat, comprising:
a tubular body having an uphole end for connection to a tubing string and a downhole intake end for receiving production fluid from the formation; and
a diffuser located in the body, extending generally axially therein from the throat and continuously curving therealong to a discharge end in the body, the diffuser forming an annular space between the diffuser and the body, the annular space acting as a production conduit in fluid communication with the intake end for delivering the production fluid to the plurality of ports,
wherein the tubular body and diffuser are additively and subtractively formed as a monolithic structure.

2. The jet pump of claim 1 wherein, when deployed in a wellbore and forming an annulus therebetween, a cross-sectional area at the discharge end of the diffuser is about a cross-sectional area of the annulus.

3. The jet pump of claim 1 further comprising a one-way valve formed in the production conduit adjacent the intake end of the body for allowing production fluid into the production conduit, the one-way valve being formed integral with the monolithic structure.

4. The jet pump of claim 1 wherein the venturi and throat are releasably supported in the body.

5. The jet pump of claim 1 wherein the throat is a one piece throat, additively and subtractively manufactured of a variable metal composition comprising at least a first metal and an abrasion resistant material, an inner surface of the throat having a greater amount of the abrasion resistant material thereat.

6. The jet pump of claim 5 wherein the abrasion resistant material is tungsten carbide.

7. The jet pump of claim 1 wherein the diffuser is formed of at least a first metal and an abrasion resistant material, an inner surface of the diffuser having a greater amount of the abrasion resistant material thereat.

8. The jet pump of claim 7 wherein the abrasion resistant material is tungsten carbide.

9. The jet pump of claim 1 wherein the diffuser is generally ovoid in cross-section.

10. The jet pump of claim 9 wherein a major axis of the diffuser is directed radially toward the discharge end.

11. The jet pump of claim 1 further comprising:
a radially extending protrusion along the body localized along the production conduit for increasing a cross-sectional area thereof.

12. The jet pump of claim 1 wherein the annular space is non-uniform along the diffuser.

13. The jet pump of claim 1 further comprising a radially extending, circumferential enlargement formed in the body adjacent the plurality of ports for directing the production fluid thereto.

14. A method of manufacturing a jet pump, having a venturi for delivering a power fluid to a throat located downhole thereof and a plurality of ports formed therebetween for inducing production fluid into the throat comprising:
forming a tubular body having an uphole end for connection to a tubing string and a downhole intake end for receiving production fluid from the formation;
forming a diffuser within the tubular body extending generally axially therein, forming an annular space between the diffuser and the body, the annular space acting as a production conduit in fluid communication with the intake end;
continuously curving the diffuser therealong from the throat to a discharge end in the body and tapering from narrow at the throat to wider at the discharge end for optimizing a cross-sectional area of the discharge end;
wherein the body and the diffuser are additively and subtractively formed as a monolithic structure.

15. The method of claim 14 wherein the optimized cross-sectional area at the discharge end is about that of a cross-sectional area of an annulus between the pump and a wellbore when deployed therein.

16. The method of claim 14 further comprising:
additively and subtractively forming a one-way valve in the production conduit adjacent the intake end and integral with the monolithic structure.

17. The method of claim 14 comprising:
varying a metal composition comprising at least a first metal and an abrasion resistant material while forming the diffuser, an inner surface thereof having a greater amount of the abrasion resistant material.

18. The method of claim 14 comprising:
additively and subtractively manufacturing the throat for releasable support within the body; and
varying a metal composition comprising at least a first metal and an abrasion resistant material while forming the throat, an inner surface thereof having a greater amount of the abrasion resistant material.
